(19) United States
(12) Patent Application Publication
(10) Pub. No.: US 2010/0037732 A1
(43) Pub. Date: Feb. 18, 2010

(54) CAN OPENER

(76) Inventors: Alan Randmae, Centerport, NY (US); Rein Randmae, Northport, NY (US)

Correspondence Address: TUTUNJIAN + BITETTO, P.C., 20 CROSSWAYS PARK NORTH, SUITE 210, WOODBURY, NY, 11797, US

(21) Appl. No.: 12/192,713

(22) Filed: Aug. 15, 2008

(51) Int. Cl. B67B 7/00

(52) U.S. Cl. 81/3.55

(57) ABSTRACT

A ring pull can opener utilizes two different coefficients of friction separated by a transition point on the can engaging surface of the can opener to provide increased leverage and assist in the opening action of the can. An ergonomic bulbous handle not only makes it easier to hold the opener, but also provides a greater freedom of motion of the user's wrist, thereby enabling greater leverage to be applied to the ring pull top during the opening actions.

### BACKGROUND

1. Technical Field

The present principles relate to can openers. More particularly, they relate to an apparatus for assisting in the opening of cans having a ring pull configuration.

2. Description of Related Art

The concept of can opening devices and various tools is known. However, these existing items do not consider the ergonomics of the user's hand, and/or the wrist action required to operate the same. As such, existing can openers for ring pull type cans are difficult and uncomfortable to use. Furthermore, the leverage provided by such openers is decreased due to the limited motion of the user's wrist as a result of the opener design with a straight handle.

### SUMMARY

The present principles overcome the shortfalls of the prior art by providing an ergonomic ring pull can opener that imparts increased leverage as a result of the present design.

According to one aspect, the can opener for use with ring pull tab cans includes an upper body having a first coefficient of friction, a lower body connected to the upper body. The lower body has a second coefficient of friction. A can engaging surface is formed on an underside of the connected upper and lower bodies, and includes a transition point between the upper body and the lower body. The first coefficient of friction is greater than said second coefficient of friction in order to effect operation of the opener.

According to another aspect, the can opener for use with ring pull tab cans includes a bulbous handle, and a body extending from said bulbous handle and having a ring pull tab engaging end. The bulbous handle enables the can opener to be used with the user's palm face down over a can to be opened.

The can opener includes an upper body section comprising a material having a first coefficient of friction and the lower body section comprises a material having a second coefficient of Friction, wherein a lower surface of the first and second material combine to form a top engaging surface of the can opener. A transition point on the top engaging surface is formed by a change between the first and second materials, wherein the first coefficient of friction is higher than the second coefficient of friction.

Other aspects and features of the present principles will become apparent from the following detailed description considered in conjunction with lithe accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1a is a perspective view of the ring pull can opener according to an implementation of the present principles;

FIG. 1b is a side view of the ring pull can opener according to an implementation of the present principles;

FIG. 1c is a front view of the ring pull can opener;

FIG. 1d is a bottom view of the ring pull can opener;

FIG. 2 is a plan view of the ring pull opener engaging a ring pull can according to an implementation of the present principles;

FIG. 3 is a plan view of the ring pull opener during the opening action of a can according to an implementation of the present principles;

FIG. 4 is plan view of the ring pull opener during the opening action of a can according to an implementation of the present principles; and

FIG. 5 is a plan view of the ring pull opener during the opening action of a can according to an implementation of the present principles.

### DETAILED DESCRIPTION

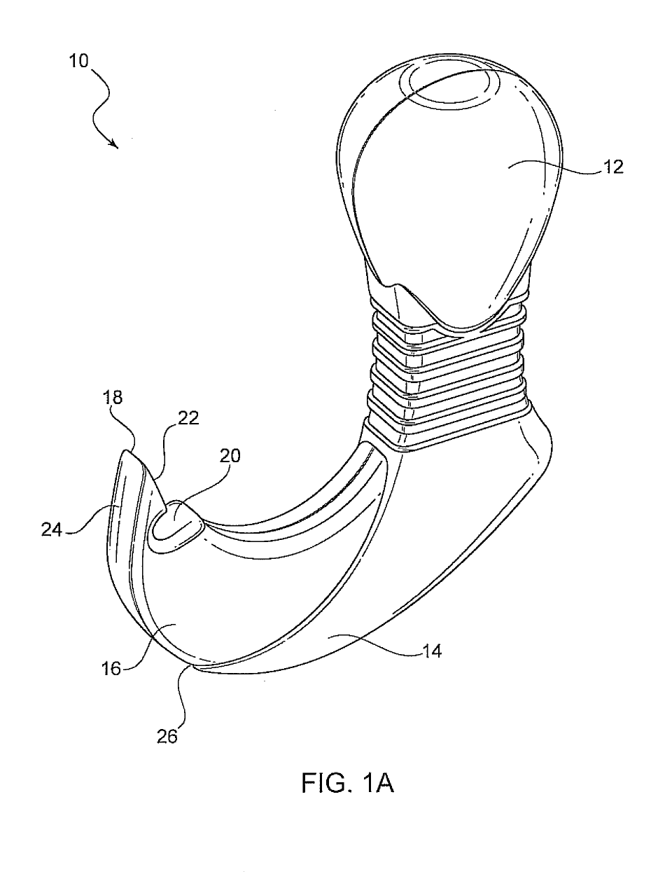

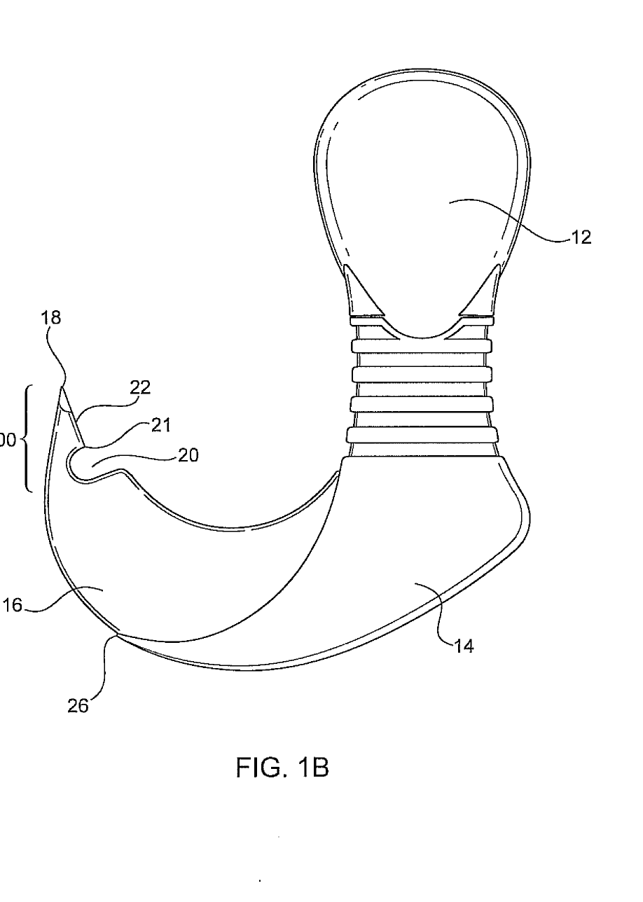

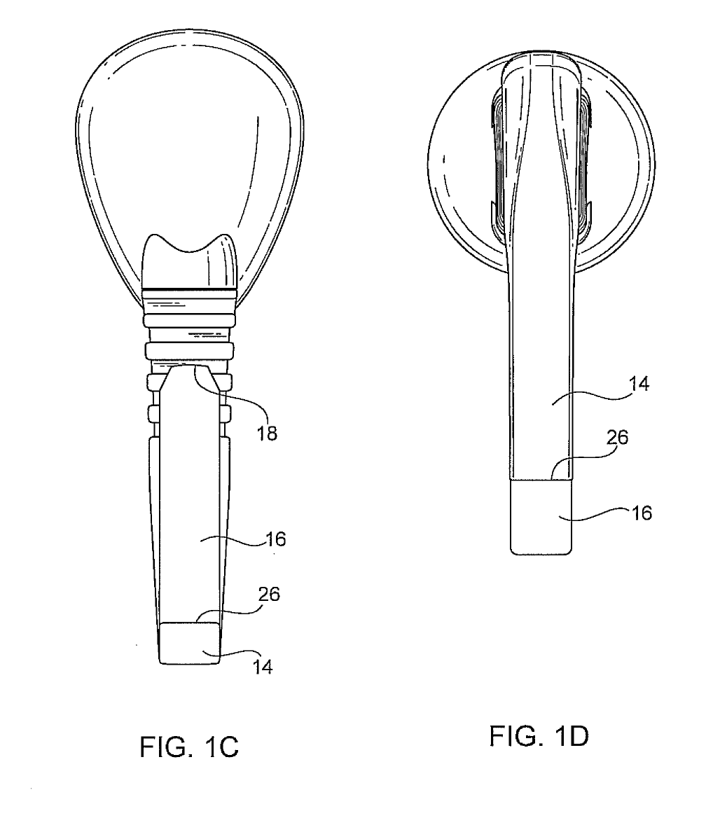

Referring to FIGS. 1a-1d, there is shown the ring pull can opener 10 according to the present principles. The opener 10 includes an upper bulbous handle 12 coupled to a first body portion 14, which is integrally connected to a second body portion 16. The second body portion 16 includes a ring pull engaging end 100 having a tip 18 configured to be inserted under a ring for pulling, and a recess 20 positioned near the tip 18. Between the tip 18 and the recess 20 is a flat surface 22 and a drop off point 21 leading to the recess 20.

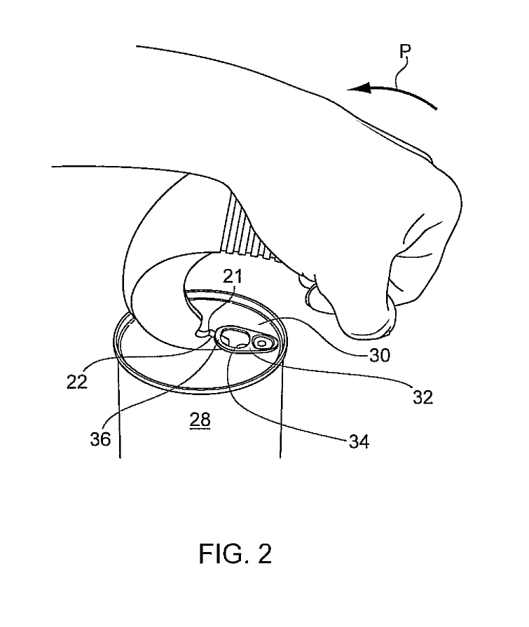

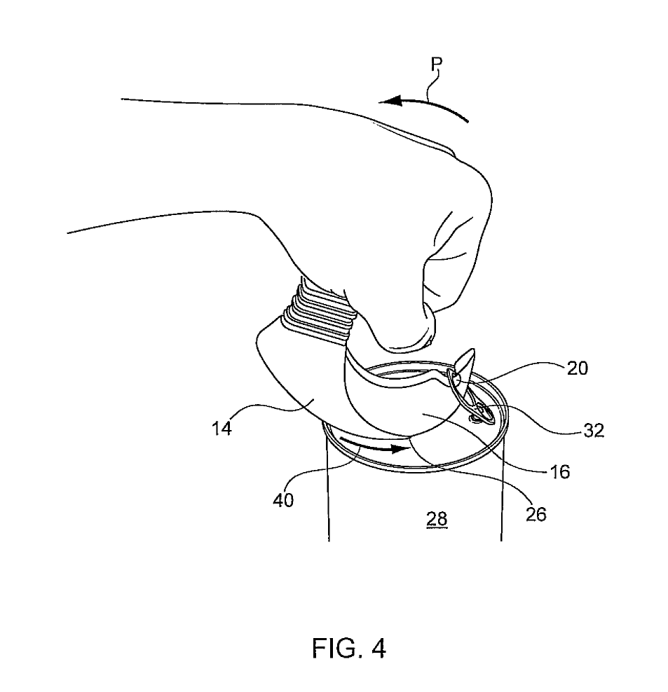

In accordance with one aspect of the present principles, the first body portion 14 and the second body portion 16 have a transition point 26 positioned on the curved can engaging surface 24 that is formed by the undersides of both portions 14 and 16. In addition, the two body portions 14 and 16 are made up of either different materials or different surface textures, each having a different coefficient of friction. As will be described below with reference to FIG. 2-5, this change in coefficient of friction between the two body portions at the transition point plays an integral role in the operation of the can opener and the ease of the same.

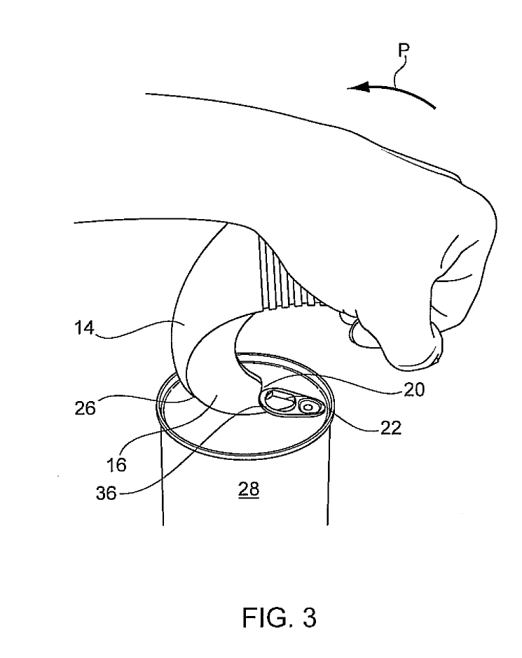

Referring to FIG. 2, the tip 18 of the opener is wedged under the ring 36 of the ring pull 32. The ring pull generally has a finger receiving hole 34 that defines the ring 36 in the ring pull 32. As the tip 18 is pushed under the ring pull 32, the ring 36 rides up easily onto the flat surface 22. With a little more pressure, the ring 36 will pass over the drop off point 21 and be engaged within the recess 20 (See FIG. 3).

The underside of the opener 10 is the can engaging surface 24. As shown in Figure 1b, the can engaging surface 24 has a distinct shape and curvature that has been specifically designed and configured to provide the highest amount of leverage during the opening action, while requiring the least amount of effort by the user.

Referring to FIGS. 3-5, once the ring 36 has been engaged within the recess 20 the user can start to pivot the opener 10 in the direction P indicated by the arrow. As the opener is pivoted back away from the ring, the can engaging surface 24 of the second body portion 16 slides on the top surface 30 of the can such that the ring 36 is lifted upward in the opening direction. When the transition point 26 on the can engaging surface 24 meets the top surface 30 of the can, the sliding action is stopped due to the higher coefficient of friction of the material making up the first body portion 14. Once the sliding action is stopped, the pivoting action P of the opener will cause the top surface 30 to be lifted from the can with the ring 36.

According to one implementation, the second body portion 16 can be made up of plastic, polycarbonate, resins or other smooth type material that exhibits a relatively low coefficient of friction to provide free-sliding action when engaged with the can top as disclosed herein. The first body portion 14 can be implemented using rubber or another rubber like substance that has a much higher coefficient of friction compared to the second body portion 16.

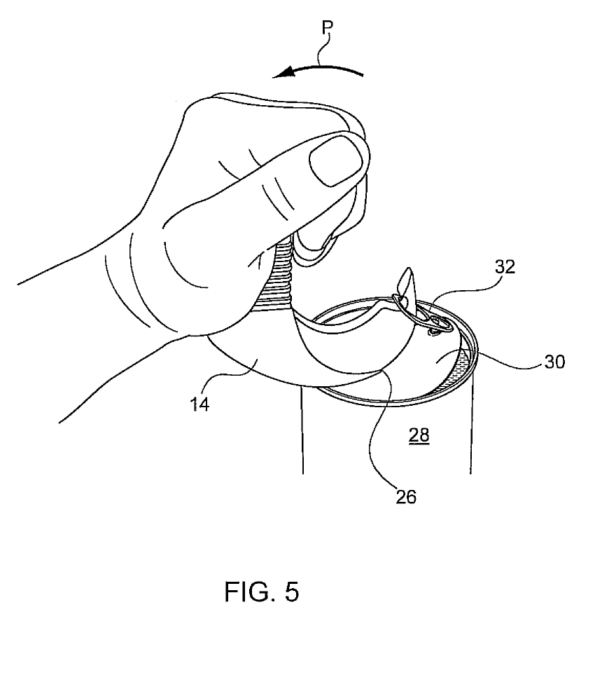

As shown in FIG. 5, once the seal between the top surface 30 and the can has been broken, the pivoting action P of the opener will easily cause the same to be opened and removable from the can. Those of skill in the art will recognize that the angles and surfaces of the underside of the opener that engage the top surface of the are designed so as to maximize the lifting action while minimizing the effort required by the user to open the ring pull can.

As mentioned briefly above, the opener includes a bulbous handle portion 12 that is designed to ergonomically fit in a user's hand. Prior to the present design, all known ring pull assisting devices include a straight arm or handle. These straight arm handles cause the user to grab the same such that the user's palm is at a 90 degree angle with respect to the top surface 30 of the can. In this configuration, the user's wrist motion required to open the can is severely limited simply because the human wrist is does not have the sufficient freedom of motion when pivoting the wrist at a right angle with respect to the floor or other surface. In prior designs, there is no provision to readjust one's hand grip on the device.

The opener of the present principles provides die bulbous handle 12 to assist in positioning the user's hand, either palm side to the left or right, or palm side down over the opened surface of the can, and thereby provides a more ergonomic means to perform the function. Typically, the user would begin the process by gripping the bulbous handle 12 with their palm either to the left or the right, and during the action of opening the can, would either slide their palm on the bulbous handle 12 to reposition to palm side down, or would pause to regrip the bulbous handle 12 with palm side down to complete the task.

In accordance with other aspects of the present principles, the bulbous handle can be made of any type of material that can be used for such applications. Examples of such material could be plastic, polycarbonate, or any other material that is comfortable to the grip of the user.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

What is claimed is:

1. A can opener for use with ring pull tab cans, the can opener comprising:
an upper body having a first coefficient of friction;
a lower body connected to the upper body, said lower body having a second coefficient of friction;
a can engaging surface formed on an underside of the connected upper and lower bodies; and
a transition point between said upper body and said lower body on said can engaging surface;
wherein said first coefficient of friction is greater than said second coefficient of friction.

2. The can opener of claim 1, further comprising:
a ring pull engaging end configured on the lower body and having a tip, and a recess configured to receive the ring pull tab and retain the same during an opening operation.

3. The can opener of claim 1, further comprising a bulbous handle connected to the upper body and configured to comfortably fit within a user's hand.

4. The can opener of claim 4, wherein said upper body and said lower body are formed of the same material.

5. The can opener of claim 4, wherein said upper body and said lower body are formed of different materials

6. The can opener of claim 4, wherein said bulbous handle is made of material different than said upper and lower body parts.

7. A can opener for use with ring pull tab cans, the can opener comprising:
a bulbous handle;
a body extending from said bulbous handle and having a ring pull tab engaging end.

8. The can opener according to claim 7, wherein said bulbous handle enables the can opener to used with the user's palm face down over a can to be opened.

9. The can opener of claim 7, wherein said body includes an upper body section comprising a material having a first coefficient of friction and said lower body section comprises a material having a second coefficient of friction, wherein a lower surface of said first and second material combine to form a top engaging surface of the can opener.

10. The can opener of claim 9, further comprising a transition point on the top engaging surface formed by a change between said first and second materials, wherein said first coefficient of friction is higher than said second coefficient of friction.
